(19) United States
(12) Patent Application Publication
(10) Pub. No.: US 2016/0305301 A1
(43) Pub. Date: Oct. 20, 2016

(54) RESERVOIR FOR GAS TREATMENT DEVICE HAVING LOOSE FILL INSULATION AND AN ASSOCIATED METHOD OF USE

(71) Applicant: Tenneco Automotive Operating Company Inc., Grass Lake, MI (US)

(72) Inventors: Steven Freis, Ann Arbor, MI (US); Stephen J. Myers, Owosso, MI (US); Michael A. Golin, Dexter, MI (US)

(21) Appl. No.: 14/687,211

(22) Filed: Apr. 15, 2015

(51) Int. Cl. F01N 3/28; F01N 3/021; B01D 53/94

(52) U.S. Cl. CPC F01N 3/2864; B01D 53/94; F01N 3/0211

(57) ABSTRACT

An exhaust gas treatment device, which includes an outer layer, an inner layer that is at least in part disposed within the outer layer, and an insulation material disposed in an enclosed space between the outer layer and the inner layer, where at least one reservoir disposed with the insulation material is connected to the enclosed space and in fluid communication therewith and a manufacturing method that includes placing an insulation material into an enclosed space between an inner layer and an outer layer for an exhaust gas treatment device and placing the insulation material into a reservoir connected to the enclosed space and in fluid communication therewith.

### BACKGROUND

It is known in the automotive industry to include an exhaust gas treatment device or system such as one utilizing an exhaust manifold, muffler, gasoline particulate filters or diesel particulate filters and/or one or more catalytic units, such as a catalytic converter, diesel oxidation catalyst unit, or selective catalytic reduction catalyst unit, to collect, direct, provide acoustic benefits and/or improve the emissions in the exhaust. Currently, what are generally referred to as batts, blankets, or mats, are utilized in exhaust gas systems in order to provide thermal insulation and/or resilient mounting structure for acoustic and aftertreatment devices of the system to control the heat exchange to and from the devices and/or provide a protective mount for a core or other fragile components of the exhaust gas treatment devices.

### SUMMARY

This section provides a general summary of the disclosure and is not a comprehensive disclosure of its full scope or all of its features.

An illustrative, but nonlimiting, aspect of this invention provides an exhaust gas treatment device with an outer layer, an inner layer that is at least in part disposed within the outer layer, an insulation material disposed in an enclosed space between the outer layer and the inner layer, wherein the outer layer and the inner layer are sealed to retain the insulation material within the enclosed space; and at least one reservoir connected to the enclosed space and in fluid communication therewith, wherein the at least one reservoir comprises at least one cavity that is extended to the enclosed space, wherein the insulation material is disposed in the at least one cavity.

Another aspect of this invention provides a method for insulating an exhaust gas treatment device includes placing an insulation material into an enclosed space between an outer layer and an inner layer, wherein the inner layer is at least in part disposed within the outer layer and the outer layer and the inner layer are sealed to retain the insulation material within the enclosed space, and placing the insulation material into at least one reservoir connected to the enclosed space in fluid communication therewith, wherein the at least one reservoir comprises at least one cavity that is extended to the enclosed space and the insulation material is disposed in the at least one cavity.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a schematic view showing an exemplary embodiment of an exhaust gas system of the present invention;

FIG. 2A is the first cut-away side view of an exemplary embodiment of an exhaust gas treatment device of the present invention having a reservoir;

FIG. 2B is the second cut-away side view of an exemplary embodiment of an exhaust gas treatment device of the present invention that does not include a reservoir in a service state;

FIG. 2C is the third cut-away side view of an exemplary embodiment of an exhaust gas treatment device of the present invention having a reservoir in a service state;

FIG. 2D is a cut-away front view of an exemplary embodiment of an exhaust gas treatment device of the present invention having a single reservoir at the twelve o'clock position and dual reservoirs at the six o'clock position;

FIG. 2E is a cut-away front view of an exemplary embodiment of an exhaust gas treatment device of the present invention having dual reservoirs at the twelve o'clock position and a single reservoir at the six o'clock position;

FIG. 3A is a cut-away front view of an alternative exemplary embodiment of an exhaust gas treatment device of the present invention having multiple reservoirs that are circumferentially positioned;

FIG. 3B is a cut-away side view of an alternative exemplary embodiment of an exhaust gas treatment device of the present invention having multiple reservoirs that are circumferentially positioned as shown in FIG. 3A;

FIG. 4A is a cut-away front view of another alternative exemplary embodiment of an exhaust gas treatment device of the present invention having multiple reservoirs that are longitudinally positioned;

FIG. 4B is a cut-away side view of another alternative exemplary embodiment of an exhaust gas treatment device of the present invention having multiple reservoirs that are longitudinally positioned as shown in FIG. 4A;

FIG. 5A is a cut-away side view of another alternative exemplary embodiment of an exhaust gas treatment device of the present invention having a reservoir with a filling mechanism;

FIG. 5B is an enlarged, isolated, cut-way side view of the another alternative exemplary embodiment of an exhaust gas treatment device of the present invention having a reservoir shown in FIG. 5A;

FIG. 6A is a cut-away side view of another alternative exemplary embodiment of an exhaust gas treatment device of the present invention having multiple reservoirs;

FIG. 6B is an enlarged, isolated, cut-way side view of another alternative exemplary embodiment of an exhaust gas treatment device of the present invention having a reservoir placed inside of the exhaust gas treatment device shown in FIG. 6A;

FIG. 6C is a perspective view of another alternative exemplary embodiment of an exhaust gas treatment device of the present invention having a reservoir placed inside of the exhaust gas treatment device shown in FIG. 6A;

FIG. 7A is the first cut-away front view of an exemplary embodiment of an exhaust gas treatment device of the present invention having an insulation layer;

FIG. 7B is an enlarged cut-way front view of an exemplary embodiment of an exhaust gas treatment device of the present invention having an insulation layer as shown in FIG. 7A;

FIG. 8 is the second cut-way side view of an exemplary embodiment of an exhaust gas treatment device of the present invention having an insulation layer with a reservoir and dual fill openings; and

FIG. 9 is a flowchart illustrating an exemplary method for insulating an exhaust gas treatment device of the present invention having a reservoir.

Reference characters in the written specification indicate corresponding items shown throughout the drawing figures.

### DETAILED DESCRIPTION

In the following detailed description, numerous specific details are set forth in order to provide a thorough understanding of the invention. The following disclosed embodiments, however, are merely representative of the invention, which may be embodied in various forms. It will be understood by those skilled in the art that the present invention may be practiced without these specific details. Thus, specific structural, functional, and procedural details described are not to be interpreted as limiting. In other instances, well-known methods, procedures, and components have not been described in detail so as to obscure the present invention.

Certain aspects of the present invention are drawn to an exhaust gas treatment device or an exhaust gas system wherein at least a part of the device or an element or component in the system utilizes a loose-fill insulation. In certain illustrative, but nonlimiting, embodiments, the loose-fill insulation may be used in place of or in addition to the types of insulation currently used in such systems or devices, such as the current use of fiber glass or ceramic mat insulation. The loose-fill insulation may provide, for example, thermal and/or acoustic insulation to the system or device. The loose-fill insulation, however, densifies since the loose-fill insulation condenses when subjected to gravity, vibration, and heat, and compacts due to the temperature differential between an inner tube and an outer tube with the inner tube expanding faster than the outer tube, which in turn creates a void space inside of the system. This void space is likely to undermine the thermal and/or acoustic insulation effect on the system. Therefore, densification, for the purpose of this patent application, is defined as the combination of both condensation and compaction as referenced above. In certain illustrative, and nonlimiting, embodiments, the system comprises a reservoir having a cavity filled up with insulation material such that the insulation material inside of the reservoir moves to fill up the void space created by the eventual densification, i.e., condensing and compaction, of the loose-fill insulation inside of the system. Illustrative, but nonlimiting, methodologies include manufacturing an exhaust gas treatment device or exhaust gas system comprising a reservoir filled up with insulation material to minimize effectively any potential loss to the thermal and/or acoustic insulation effect due to the densification of the insulation material.

The exhaust gas system or device of the invention may be any known exhaust gas system or device that comprises at least one volume wherein a loose-fill insulation may be encompassed or contained. For example, a component of an exhaust gas system may be placed within another structure, e.g., an exhaust pipe placed inside of an outer housing pipe of larger diameter, wherein a volume of space is formed between them that can be filled with a loose-fill insulation. In certain other embodiments, a component of an exhaust gas system may be placed within another structure, e.g., a solid catalytic monolith placed inside of a housing or can, wherein a volume of space is formed between them that can be filled with a loose-fill insulation. Nonlimiting, representative examples of an exhaust gas system or device of the invention include a manifold, a manifold with a three-way catalyst, connecting pipe, muffler, emissions control unit, selective catalytic reduction (SCR) catalyst, diesel particulate filter (DPF), gasoline particulate filter (GPF), thermal regeneration unit, decomposition tube, injector mounting location, a mixer, a diesel oxidation catalyst (DOC), a duct and box system, and the like.

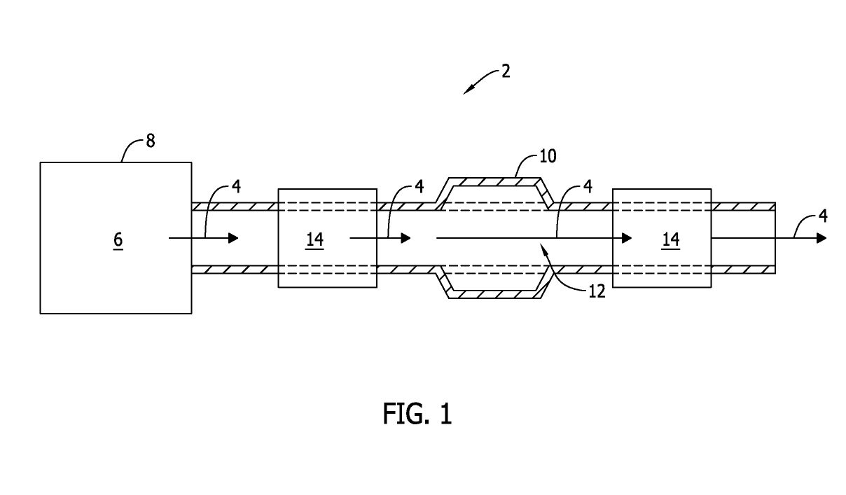

FIG. 1 is a schematic view showing an exemplary embodiment of an exhaust gas system of the present invention generally indicated by numeral 2, in the form of a diesel exhaust gas aftertreatment system to treat the exhaust gases 4 from a combustion process 6, such as from a diesel compression engine 8. The system may include one or more exhaust gas acoustic and/or aftertreatment devices or components. Representative examples of such devices include catalytic converters, diesel oxidation catalysts, diesel particulate filters, gas particulate filters, lean NOₓ traps, selective catalytic reduction (SCR) catalysts, burners, manifolds, connecting pipes, mufflers, resonators, tail pipes, emission control system enclosure boxes, insulation rings, insulated end cones, insulated inlet pipes, and insulated outlet pipes. Some of these devices are components 10 having a central opening 12 through which exhaust gases 4 flow. The components may be made of various materials but often metal, such as stainless steel in the 300 or 400 family is used. In certain embodiments, these components are strictly metallic. Other devices can include a core 14, for example, in the form of a ceramic monolith structure and/or a woven metal structure through which the exhaust flows. These devices or systems are utilized, for example, in gasoline, diesel, and other combustion engine motor vehicles, construction equipment, lawn care equipment, locomotive engine applications, marine engine applications, small internal combustion engines, and stationary power generation.

As previously referenced above, an exhaust gas treatment device comprises an outer layer encompassing an inner layer that is at least in part disposed within the outer layer in certain embodiments of the present invention. In certain embodiments, at least one end of the inner layer is configured and adapted to receive exhaust gases either directly or indirectly from an engine. In many exhaust gas treatment devices, an inner layer is disposed at least in part within an outer layer. Often there is a volume of space between the inner and outer layers. This space may itself impede thermal transfer between the inner layer and the outer layer. The space may additionally be filled with insulation to prevent further thermal transfer. However, often the inner layer and the outer layer come into close proximity or contact in at least one area, often at one or more ends of the exhaust gas treatment device.

In certain embodiments, at least a portion of the outer layer of an exhaust gas treatment device is coated, such as for decorative purposes, e.g., chrome coating. For example, although the look of a chrome exhaust is often desired, high exhaust temperatures can lead to discoloration of chrome. In certain embodiments, the loose-fill insulation disposed between the outer layer and the inner layer sufficiently blocks the transfer of heat from the inner layer to the outer layer, such that discoloration of the chrome can be prevented.

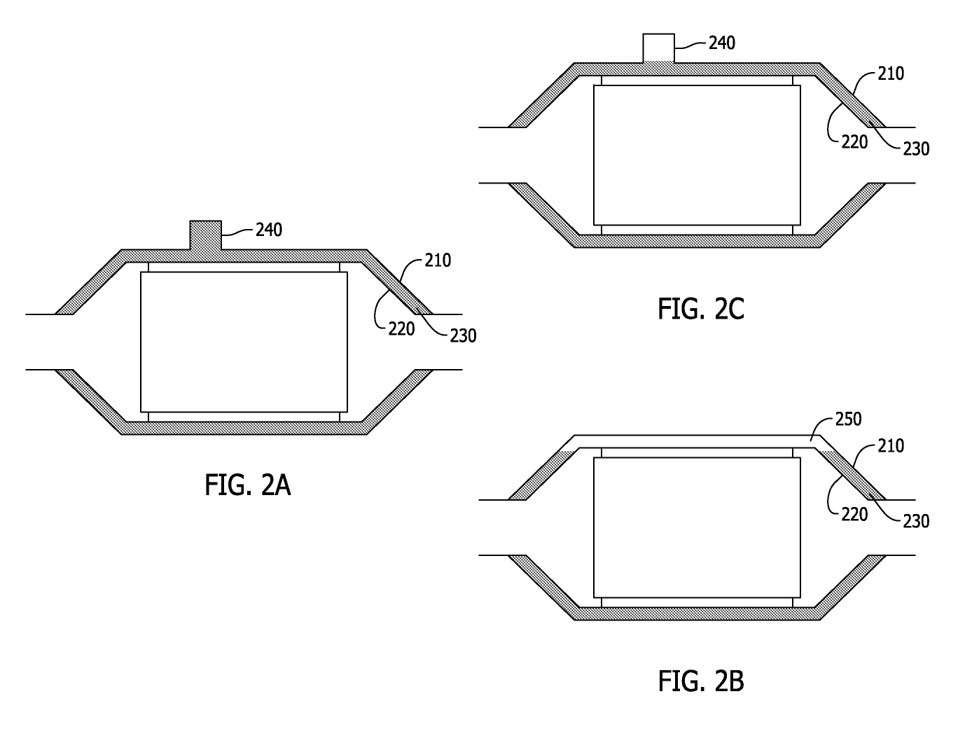

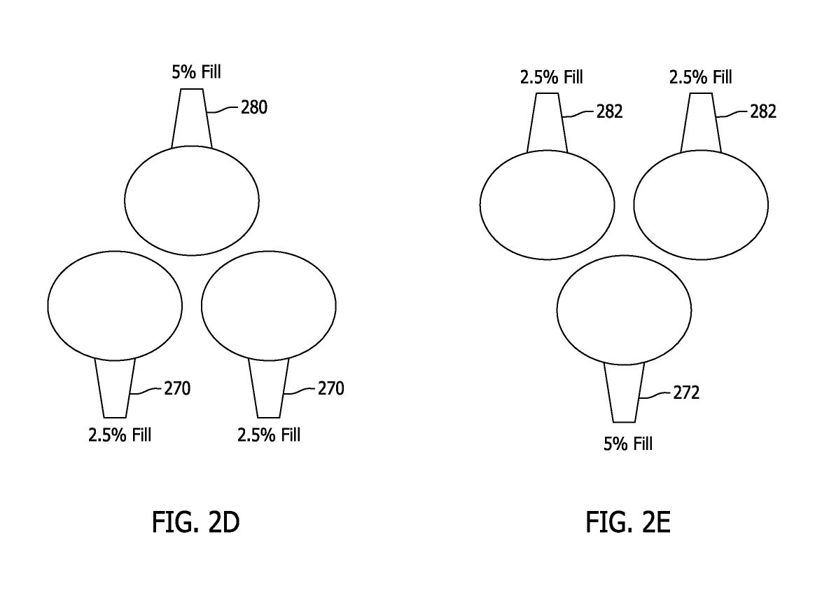

FIG. 2A is a cut-away side view showing an exemplary embodiment of an exhaust gas treatment device of the invention having a reservoir. The exemplary embodiment comprises an outer layer 210, an inner layer 220, an enclosed space 230, and a reservoir 240. The inner layer 220 is at least in part disposed within the outer layer 210 such that the enclosed space 230 is formed between the inner layer 220 and the outer layer 210 as shown in FIG. 2A. The reservoir 240 is preferably, but not necessarily, projected vertically from the outer layer 210. In the illustrative, but nonlimiting, exemplary embodiment, the reservoir 240 comprises a cavity extended to the enclosed space 230 and in fluid communication therewith. An insulation material can be disposed in the enclosed space 230 and/or the reservoir 240, as shown in FIG. 2A.

When the insulation material densifies (for example, due to gravity, vibration, heat, compaction, and so forth), a void space 250 can be created in the enclosed space 230 as shown in FIG. 2B. This void space 250 creates an uninsulated area particularly on the top of the device. In order to avoid such undesirable consequence, the reservoir 240 is added to the exhaust gas treatment device of the invention. As shown in FIG. 2C, the insulation material contained in the reservoir 240 moves into the enclosed space 230 to fill up the void space 250 created by the eventual densification of the insulation material in the enclosed space 230. FIGS. 2B and 2C illustrate an “in-service” state.

In an illustrative, but nonlimiting, embodiment, the volume of the insulation material contained in the reservoir 240 can be configured to be proportional to a rate in which the insulation material that is being used densifies. The rate in which the insulation material densifies represents a ratio of the difference between the volume of the insulation material in the enclosed space 230 after the insulation material densifies and the volume of the insulation material in the enclosed space 230 before the insulation material densifies to the volume of the insulation material in the enclosed space 230 before the insulation material densifies. For example, as a nonlimiting illustration only, if the volume of the insulation material in the enclosed space 230 before the insulation material densifies is 100 and the volume of the insulation materials in the enclosed space 230 after the insulation material densifies is 90, then the rate in which this insulation material densifies is calculated as (100−90)/100=10%. Preferably, the rate of densification ranges from about three percent (3%) to about ten percent (10%). Alternatively, the volume of the reservoir 240 can be configured to be proportional to a rate the insulation material that is being used densifies. However, it should be understood that the volume of the insulation material contained in the reservoir 240 can also be determined by any other applicable method or standard that does not incorporate the information regarding the rate that the insulation material densifies.

In an illustrative, but nonlimiting, embodiment, the reservoir 240 comprises a cylindrical projection perpendicular to the outer layer 210. However, the reservoir 240 can also comprise a myriad of other structures or designs such as a rectangular projection(s), semicircular projection(s), and triangular projection(s) preferably, but not necessarily, perpendicular to the outer layer 210. Moreover, a plurality of reservoirs 240 can be configured.

In an illustrative, but nonlimiting, embodiment, the reservoir 240 can be configured to be positioned at any orientation of the outer layer 210. For example, the reservoir 240 can be positioned at the twelve o'clock position or the six o'clock position. Additionally, when the device is mounted in a vehicle, the reservoir 240 can be configured to be positioned at the uppermost point of the device regardless of how and where the device is mounted or positioned in relation to the vehicle. This is to assure that the insulation material in the reservoir 240 moves down to the void space created due to the eventual densification of the insulation material disposed in the enclosed space. Because the insulation typically densifies from top to bottom (due to gravity), the reservoir 240 is preferably configured to be positioned at the uppermost point of the device when the device is mounted in a vehicle.

In an illustrative, but nonlimiting, embodiment, the volume of the insulation material disposed in a reservoir can also be determined by the location of a reservoir. For example, as shown in FIG. 2D, there are dual reservoirs 270 that are placed at the six o'clock position containing 2.5% for each fill volume and configured to each contain half the volume of the insulation material disposed in the reservoir 280 that is located at the twelve o'clock position containing 5% fill volume. It follows that, as shown in FIG. 2E, if there are dual reservoirs 282 that are placed at the twelve o'clock position containing 2.5% for each fill volume and configured to each contain half the volume of the insulation material disposed in the reservoir 272 that is located at the six o'clock position containing 5% fill volume. Optimally, but not necessarily, the amount of volume in the upper reservoirs is substantially similar to the amount of volume for the insulation in the lower reservoirs.

In an illustrative, but nonlimiting, embodiment, a foam (not shown) can be created inside of the enclosed space in order to reduce movement of the insulation material in the enclosed space when a void space is created due to densification of the insulation material. Illustrative, but nonlimiting, types of foam include phenolic foam, nitrile rubber foam, ceramic fiber foam, and so forth.

In an illustrative, but nonlimiting, embodiment, the reservoir 240 can be configured to comprise at least one window (not shown) that can be used to verify visually whether additional insulation material is needed in the reservoir 240. For example, a window made of glass or transparent plastic can be placed on one of the sides of the reservoir 240, allowing visual inspection of how much insulation material is left in the reservoir 240. If it is determined that more insulation material is required to ensure proper insulation, then additional insulation material can be disposed in the reservoir 240.

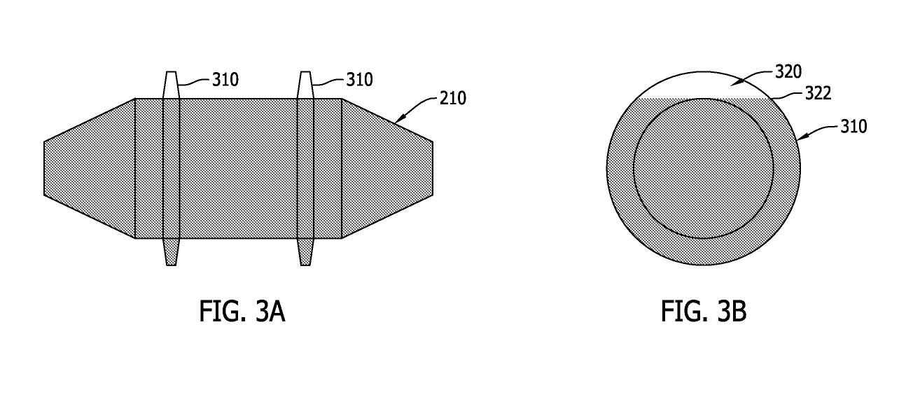

FIG. 3A is a cut-away side view showing an alternative exemplary embodiment of an exhaust gas treatment device of the invention having a reservoir. In this alternative exemplary embodiment, a reservoir 310 is configured to have a ring-type structure that can be placed around the surface of the outer layer 210 as shown in FIG. 3A. As discussed above in reference to FIG. 2A, the reservoir 310 comprises a cavity, which is circumferentially located, in which the insulation material can be disposed. The cavity is extended to an enclosed space and in fluid relationship therewith. When the insulation material densifies, as shown in FIG. 3B, the insulation material stored in the reservoir 310 moves to the enclosed space to fill up a void space 320 created due to the densification of the insulation material in the enclosed space. Additionally, a plurality of the reservoirs 310 can be configured in this embodiment as shown in FIG. 3A.

In an illustrative, but nonlimiting, embodiment, the volume of the insulation material in the reservoir 310 can be determined by a drop level 322 of the insulation material as shown in FIG. 3B. For example, the volume of the insulation material contained in the reservoir 310 can be determined such that the insulation material in the reservoir 310 does not go down below the drop level 322 when the insulation material in the reservoir 310 moves to the enclosed space to fill up a void space 320 created due to densification of the insulation material disposed in the enclosed space. If the insulation material in the reservoir 310 drops below the drop level 322, then an extra layer of insulation can be used to fill up or conceal the void space 320 created in the reservoir 310. Alternatively, instead of controlling the volume of the insulation material contained in the reservoir 310, the size of the reservoir 310 can be determined by the drop level 322. In this alternative embodiment, the volume of the insulation material can be determined according to the size of the reservoir 310.

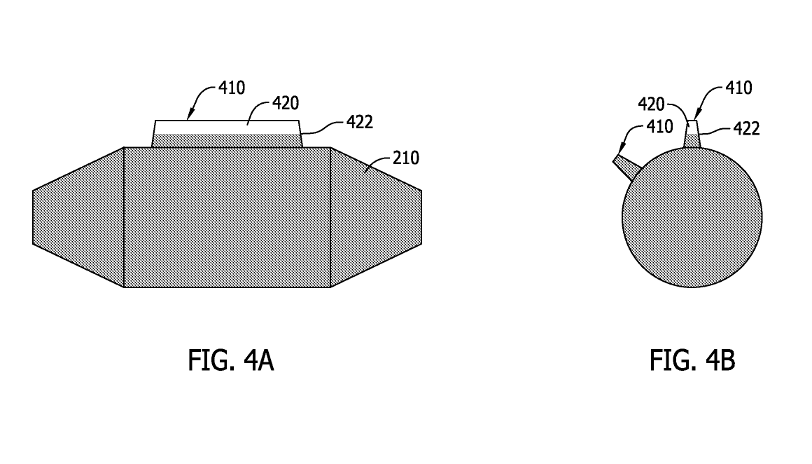

FIG. 4A is a cut-away side view showing another alternative exemplary embodiment of an exhaust gas treatment device of the invention having a reservoir. In this alternative exemplary embodiment, a reservoir 410 is configured to be axially or longitudinally placed along the surface of the outer layer 210 as shown in FIG. 4A. As discussed above in reference to FIG. 2A, the reservoir 410 comprises a cavity in which the insulation material can be disposed. The cavity is extended to the enclosed space. When the insulation material densifies, the insulation material stored in the reservoir 410 moves to the enclosed space to fill up a void space 420 created due to the densification of the insulation material in the enclosed space. Additionally, a plurality of reservoirs 410 can be configured in this embodiment as shown in FIG. 4B.

In an illustrative, but nonlimiting, embodiment, the volume of the insulation material in the reservoir 410 can be determined by a drop level 422 due to densification as shown in FIG. 4A. For example, the volume of the insulation material contained in the reservoir 410 can be determined such that the insulation material in the reservoir 410 does not fall below the drop level 422 due to densification when the insulation material in the reservoir 410 moves to the enclosed space to fill up the void space 420 created due to densification of the insulation material disposed in the enclosed space. If the insulation material in the reservoir 410 falls below the drop level 422, then extra insulation later can be used to fill up or conceal the void space 420 created in the reservoir 410. Alternatively, instead of controlling the volume of the insulation material contained in the reservoir 410, the size of the reservoir 410 can be determined by the drop level 422. In this alternative embodiment, the volume of the insulation material can be determined according to the size of the reservoir 410.

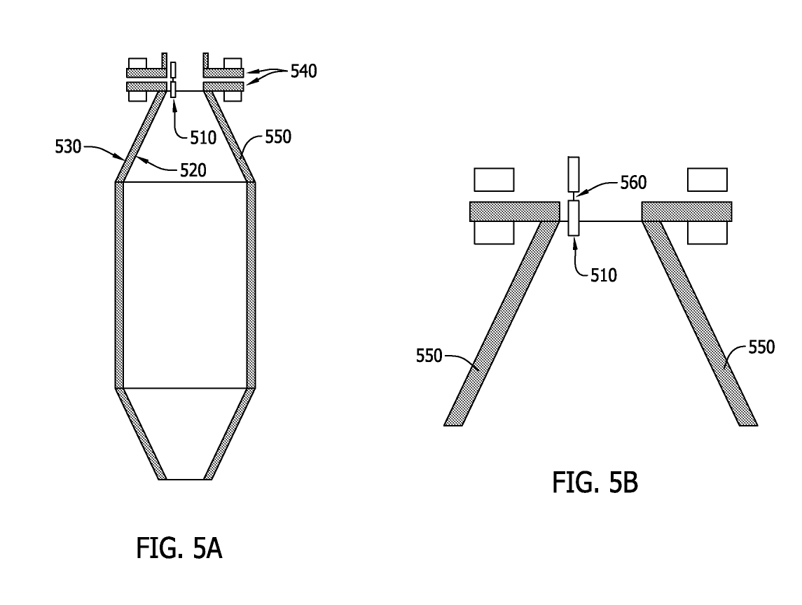

FIG. 5A is a cut-away side view showing another alternative exemplary embodiment of an exhaust gas treatment device of the invention having a reservoir. In this exemplary embodiment, a reservoir 510 is placed inside of the device as shown in FIG. 5A. For example, the reservoir 510 is projected from the inner layer 520 of the device. As discussed in reference to FIG. 2A, the reservoir 510 comprises a cavity in which the insulation material can be disposed. The cavity is extended to the enclosed space created between an outer layer 530 and an inner layer 520. The reservoir 510 is configured to extend past service flanges 540. In this illustrative, but nonlimiting, embodiment, after disposing the insulation material in the enclosed space 550, the service flanges 540 are connected together by a variety of mechanisms, e.g., welding, bolts, and so forth. When the insulation material in the enclosed space 550 densifies, the insulation material in the reservoir 510 moves down to the enclosed space 550 to fill up a void space created in the enclosed space 550 due to densification of the insulation material disposed in the enclosed space 550. Additionally, a plurality of the reservoirs 510 can be configured in this embodiment.

In this particular illustrative, but nonlimiting, embodiment, the volume of the insulation material in the reservoir 510 can be determined by a drop level 560 for the insulation material as shown in FIG. 5B. For example, the volume of the insulation material contained in the reservoir 510 can be determined such that the insulation material in the reservoir 510 does not fall below the drop level 560 when the insulation material in the reservoir 510 moves to the enclosed space 550 to fill up a void space created due to the densification of the insulation material disposed in the enclosed space 550. If the insulation material in the reservoir 510 drops below the drop level 560, then an extra insulation layer can be used to fill up or conceal the void space created in the reservoir 510. Alternatively, instead of controlling the volume of the insulation material contained in the reservoir 510, the size of the reservoir 510 can be determined by the drop level 560. In this alternative embodiment, the volume of the insulation material can be determined according to the size of the reservoir 510.

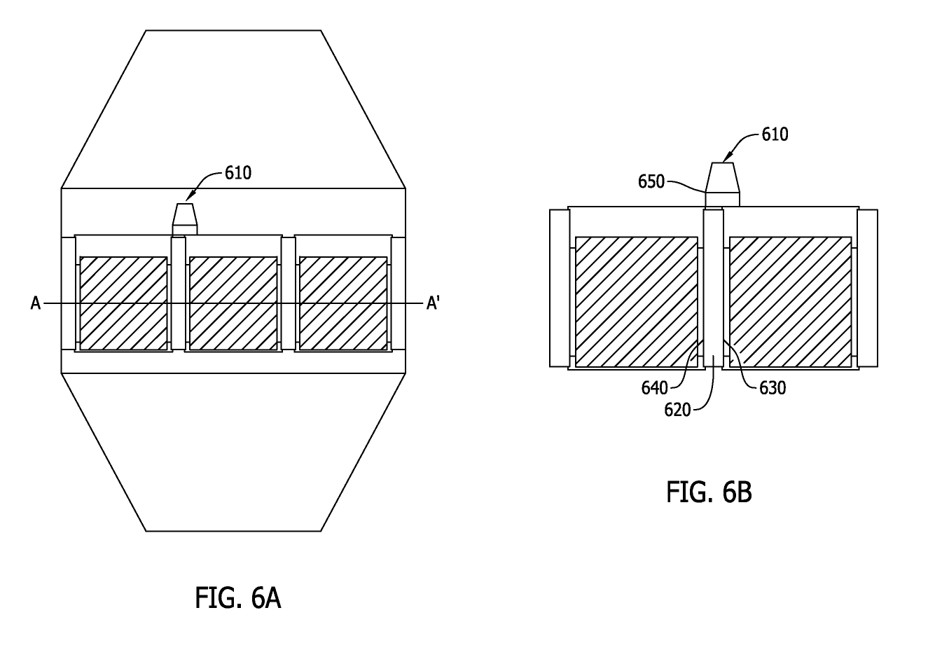

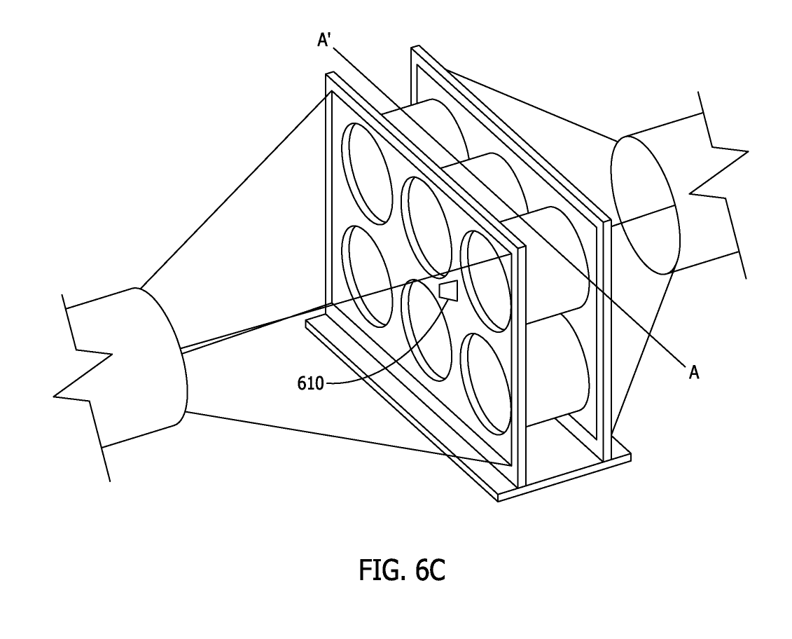

FIG. 6A is a cut-away side view showing another alternative exemplary embodiment of an exhaust gas treatment device of the invention having a reservoir. In this embodiment, a reservoir 610 is placed inside of the device as shown in FIG. 6A. As discussed above in reference to FIG. 2A, the reservoir 610 comprises a cavity in which the insulation material can be disposed. The cavity is extended to an enclosed space 620 created between two inner layers 630 and 640 as shown in FIG. 6B. When the insulation material in the enclosed space 620 densifies, the insulation material in the reservoir 610 moves into the enclosed space 620 to fill up a void space created in the enclosed space 620 due to the densification of the insulation material disposed in the enclosed space 620. FIG. 6C is a perspective view showing another alternative exemplary embodiment of the exhaust gas treatment device shown in FIG. 6A. As shown in FIG. 6C, the reservoir 610 is placed on top of the enclosed space 620 created between the inner layers of the pipes of the exhaust gas treatment device. Additionally, a plurality of the reservoirs 610 can be configured in this embodiment.

In an illustrative, but nonlimiting, embodiment, the volume of the insulation material in the reservoir 610 can be determined by a drop level 650 for densification of the insulation material as shown in FIG. 6B. For example, the volume of the insulation material contained in the reservoir 610 can be determined such that the insulation material in the reservoir 610 does not fall below the drop level 650 when the insulation material in the reservoir 610 moves to the enclosed space 620 to fill up a void space created due to densification of the insulation material disposed in the enclosed space 620. If the insulation material in the reservoir 610 falls below the drop level 650, then an extra insulation layer can be used to fill up or conceal the void space created in the reservoir 610. Alternatively, instead of controlling the volume of the insulation material contained in the reservoir 610, the size of the reservoir 610 can be determined by the drop level 650. In this alternative embodiment, the volume of the insulation material can be determined according to the size of the reservoir 610.

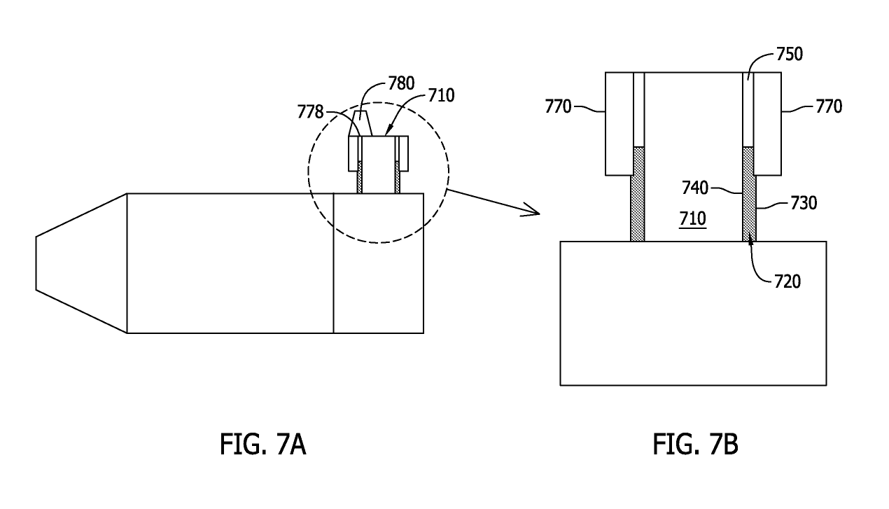

FIG. 7A is a cut-away side view showing an exemplary embodiment of an exhaust gas treatment device of the invention having an insulation layer. In this exemplary embodiment, the device comprises a flow neck 710. In this illustrative, but nonlimiting, embodiment, there is a fill-hole 778 through which insulation material can be disposed into an enclosed space 720 with a detachable fill funnel 780. In this exemplary embodiment, an extra insulation layer 770 can be used to cover up the fill-hole 778 after the insulation material is disposed in the enclosed space 720. This extra insulation layer 770 is preferably nondensifying and provides the required skin temperature. This extra insulation layer 770 can include a wide variety of materials, including, but not limited to common ceramic fiber mats or batts. Illustrative, but nonlimiting examples, include: IsoMax® 110, which is a federally registered trademark of Unifrax I LLC, having a place of business at 2351 Whirlpool Street, Niagara Falls, N.Y. 14305-2413; E100N™, manufactured by Isover Saint-Gobain, having a place of business at Via Ettore Romagnoli, 6 20146 Milan Italy; and Asglasi™, manufactured by ASGLAWO® Technofibre GmbH, having a place of business at Lindenstraβe 2, 09627 Hilbersdorf, Germany.

The flow neck 710 comprises an enclosed space 720 between an outer layer 730 and an inner layer 740 as shown in FIG. 7B. The flow neck 710 is projected vertically from the device and functions as either an inlet or outlet for gas that passes through the device. The insulation material can be disposed in the enclosed space 720. When the insulation material disposed in the enclosed space 720 densifies, a void space 750 is created in the enclosed space 720 that can also be viewed as an air gap. An insulation layer 770 can be used to fill up or conceal the void space 750 created inside of the flow neck 710. As shown in FIG. 7B, the insulation layer 770 can be placed to externally surround the portion of the outer surface of the flow neck 710 where the void space 750 is created so as to provide additional insulation to the exhaust gas treatment device. Illustrative, but nonlimiting materials that can be used for the insulation layer 770 are described in detail above.

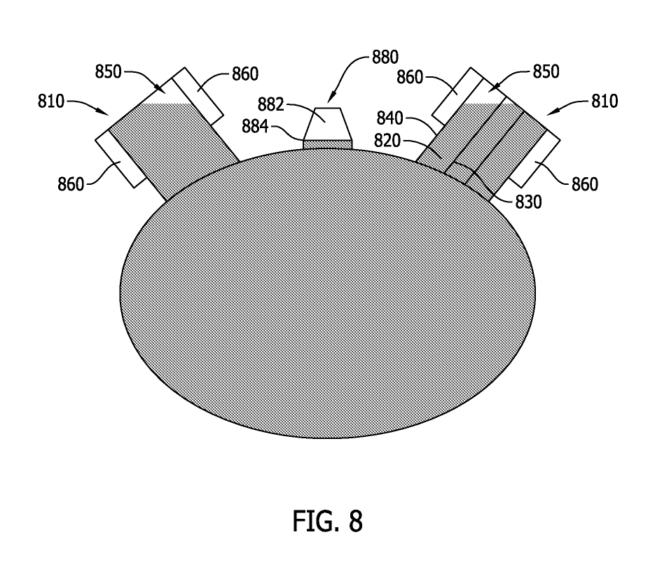

FIG. 8 is a cut-away side view showing an alternative exemplary embodiment of an exhaust gas treatment device of the invention having an insulation layer 860. In this exemplary embodiment, a flow neck 810 comprises an enclosed space 820 between an inner layer 830 and an outer layer 840. The insulation material can be disposed in the enclosed space 820. When the insulation material disposed in the enclosed space 820 densifies, a void space 850 is created to form an air gap in the enclosed space 820. An insulation layer 860 can be used to seal the void space 850 created inside of the flow neck 810 as shown in FIG. 8. The insulation layer 860 can be placed to surround the portion of the outer surface of the flow neck 810 where the void space 850 is created so as to provide additional insulation to the exhaust gas treatment device. This insulation layer 860 is preferably nondensifying and provides the required skin temperature. This insulation layer 860 can include a wide variety of materials, including, but not limited to common ceramic fiber mats or batts. Illustrative, but nonlimiting examples, include: IsoMax® 110, which is a federally registered trademark of Unifrax I LLC, having a place of business at 2351 Whirlpool Street, Niagara Falls, N.Y. 14305-2413; E100N™, manufactured by Isover Saint-Gobain, having a place of business at Via Ettore Romagnoli, 6 20146 Milan Italy; and Asglasi™, manufactured by ASGLAWO® Technofibre GmbH, having a place of business at Lindenstraβe 2, 09627 Hilbersdorf, Germany.

There is also an upper reservoir 880 that includes a void space 882 and fill line 884 that is preferably, but not necessarily, positioned in the uppermost point of a gas treatment device.

In the exemplary embodiment, the insulating material is a loose-fill insulation. The loose-fill insulation used may be any of several loose-fill insulations known in the field. Illustrative examples include aerogel, perlite, roving, string, and an insulation blanket. Additionally, the insulation material can comprise microporous insulation.

In certain embodiments, the loose-fill insulation is a material capable of absorbing moisture. Moisture refers to the presence of liquid, for example, water. In certain embodiments, such loose-fill insulation capable of absorbing moisture is provided with moisture. The moisture may be provided by the user, such as by adding water to the insulation, or the absorption of moisture that may occur during the operating cycle of the device such as from moist exhaust gases or condensation of moisture within the device. In certain embodiments, the device is configured to collect moisture or condensation and direct it into the loose-fill insulation. For example, an opening or vent may be placed in a pipe, such as at a low position where moisture or condensation collects, to allow the liquid to drain into the loose-fill insulation. The absorption of moisture by the insulation may help moderate temperature spikes, especially at the outer surface or skin of the device. During periods of operation where the rise of temperature is extreme, heat is transferred from hot exhaust gases across the inner pipe of the device into the volume of space between the inner pipe and the outer pipe. This increases the temperature of the loose-fill insulation and the moisture contained therein. If enough heat is generated, it will result in a phase change of the absorbed liquid to a gas or steam, which will absorb heat. The gas or steam generated may be allowed to escape from the device, such as through an opening or vent. In certain embodiments, the opening or vent is too small to allow the loose-fill insulation to escape or the opening or vent is covered with a mesh or screen that allows the gas or steam to escape but contains the loose-fill insulation within the device. This process of allowing moisture absorbed within the loose-fill insulation to convert to a gas or steam at high exhaust gas temperatures may aid in thermal insulation from the device such as reducing the heat transferred to the outer layer of the exhaust gas treatment device. This is ideal for exhaust assemblies dealing with the heat of regeneration. A relatively short duration of a temperature spike may be manageable by moisture—even a small amount of moisture—absorbed in the loose-fill insulation. In certain embodiments, the insulating material is capable of absorbing up to about twice its weight in water.

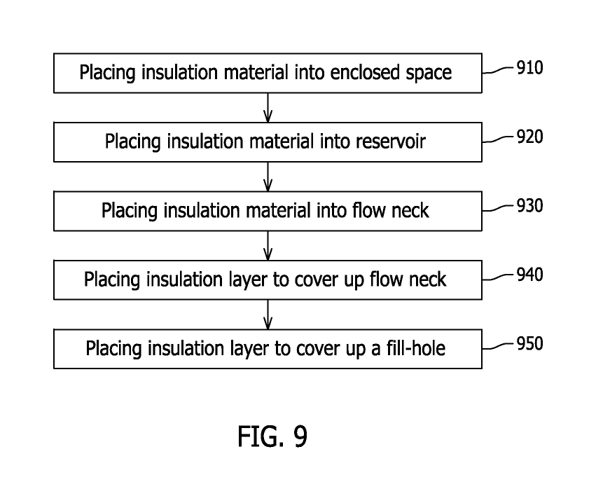

FIG. 9 is a flowchart illustrating an exemplary method for insulating an exhaust gas treatment device of the invention having a reservoir. In the description of the flowchart, the functional explanation marked with numerals in angle brackets, <nnn>, will refer to the flowchart blocks bearing that number. At step <910>, an insulation material is placed into the enclosed space 230 created between the outer layer 210 and the inner layer 220, as discussed above in reference to FIG. 2A. The inner layer 220 is at least in part disposed within the outer layer 210. The outer layer 210 and the inner layer 220 are sealed to retain the insulation material within the enclosed space 230. Although FIG. 2A is referenced herein, it should be understood that other alternative embodiments discussed above, for example, those embodiments referenced in FIG. 3A, FIG. 4A, FIG. 5A and FIG. 6A, can also be referenced with respect to FIG. 9.

At step <920>, the insulation material is placed into the reservoir 240 that is connected to the enclosed space 230, as discussed above in reference to FIG. 2A. The reservoir 240 comprises a cavity that is extended to the enclosed space 230 and in fluid communication therewith. The insulation material is disposed in the cavity. When the insulation material disposed in the enclosed space 230 densifies, the insulation material in the reservoir 240 moves to fill up a void space 250 created in the enclosed space 230. The insulation material can be disposed in the reservoir 240 through a fill-hole, as discussed above in reference to FIG. 2A.

At step <930>, the insulation material is placed into the flow neck 710, as discussed above in reference to FIG. 7A and FIG. 8. The flow neck 710 comprises the enclosed space 720 and the insulation material is disposed in the enclosed space 720 of the flow neck 710.

At step <940>, the insulation layer 770 is placed to seal the outer surface of the flow neck 710, as discussed above in reference to FIG. 7A and FIG. 8. The insulation layer 770 is placed to surround a portion of the flow neck 710 where a void space 750 is created due to the densification of the insulation material disposed in the enclosed space 720 of the flow neck 710.

At step <950>, the insulation layer 770 is placed to cover up the fill-hole 778 through which the insulation material is disposed in the flow neck 710.

It should be understood that when introducing elements of the present invention in the claims or in the above description of the preferred embodiment of the invention, the terms “have,” “having,” “includes” and “including” and similar terms as used in the foregoing specification are used in the sense of “optional” or “may include” and not as “required.” Similarly, the term “portion” should be construed as meaning some or all of the item or element that it qualifies.

Thus, there have been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications, which do not depart from the spirit and scope of the invention, are deemed to be covered by the invention, which is limited only by the claims that follow.

1. An exhaust gas treatment device comprising:
an outer layer;
an inner layer that is at least in part disposed within the outer layer;
an insulation material disposed in an enclosed space between the outer layer and the inner layer, wherein the outer layer and the inner layer are sealed to retain the insulation material within the enclosed space; and
at least one reservoir connected to the enclosed space and in fluid communication therewith, wherein the at least one reservoir comprises at least one cavity that is extended to the enclosed space, wherein the insulation material is disposed in the at least one cavity.

2. The exhaust gas treatment device according to claim 1, wherein the insulation material disposed in the at least one cavity moves to fill up a void space in the enclosed space that is created due to densification of the insulation material in the enclosed space.

3. The exhaust gas treatment device according to claim 1, wherein the at least one reservoir is projected from the outer layer.

4. The exhaust gas treatment device according to claim 3, wherein the at least one reservoir is configured to be positioned in a circumferential orientation of the outer layer.

5. The exhaust gas treatment device according to claim 3, wherein the at least one reservoir is configured to be positioned in a longitudinal orientation of the outer layer.

6. The exhaust gas treatment device according to claim 3, wherein the at least one reservoir is configured to be positioned vertically at uppermost point of the exhaust gas treatment device when the exhaust gas treatment device is mounted in a vehicle.

7. The exhaust gas treatment device according to claim 6, further comprising at least one reservoir is configured to be positioned vertically at lowermost point of the exhaust gas treatment device when the exhaust gas treatment device is mounted in a vehicle, wherein the volume of insulation in the at least one reservoir that is configured to be positioned vertically at the uppermost point of the exhaust gas treatment device is substantially similar to the volume of insulation in the at least one reservoir that is configured to be positioned vertically at the lowermost point of the exhaust gas treatment device.

8. The exhaust gas treatment device according to claim 1, wherein the insulation material is selected from the group consisting of aerogel, perlite, roving, string, and an insulation blanket.

9. The exhaust gas treatment device according to claim 8, wherein the insulation material comprises microporous insulation.

10. The exhaust gas treatment device according to claim 1, wherein a volume of insulation material stored in the at least one reservoir is proportional to a rate in which the insulation material densifies when stored in the enclosed space, wherein the rate in which the insulation material densifies represents a ratio of the difference between a volume of the insulation material in the enclosed space after the insulation material densifies and a volume of the insulation material in the enclosed space before the insulation material densifies to the volume of the insulation material in the enclosed space before the insulation material densifies.

11. The exhaust gas treatment device according to claim 10, wherein the rate in which the insulation material densifies ranges from about three to about ten percent.

12. The exhaust gas treatment device according to claim 1, wherein a volume of insulation material stored in the at least one reservoir is determined by a location of the at least one reservoir.

13. The exhaust gas treatment device according to claim 1, wherein the exhaust gas treatment device additionally comprises:
a flow neck having a second enclosed space that is connected to the outer layer, wherein the insulation material is disposed in the second enclosed space; and
an insulation layer that at least partially surrounds a portion of the flow neck where a void space is created due to a densification of the insulation material in the second enclosed space.

14. The exhaust gas treatment device according to claim 1, wherein the exhaust gas treatment device additionally comprises an insulation layer wherein the insulation material is disposed in the at least one reservoir through a fill-hole, wherein the insulation layer is used to seal the fill-hole after the insulation material is disposed in the at least one reservoir.

15. A method for insulating an exhaust gas treatment device comprising:
placing an insulation material into an enclosed space between an outer layer and an inner layer, wherein the inner layer is at least in part disposed within the outer layer and the outer layer and the inner layer are sealed to retain the insulation material within the enclosed space; and
placing the insulation material into at least one reservoir connected to the enclosed space, wherein the at least one reservoir comprises at least one cavity that is extended to the enclosed space in fluid communication therewith and the insulation material is disposed in the at least one cavity.

16. The method for insulating an exhaust gas treatment device according to claim 15, wherein the insulation material disposed in the at least one cavity moves to fill up a void space in the enclosed space that is created due to densification of the insulation material in the enclosed space.

17. The method for insulating an exhaust gas treatment device according to claim 15, wherein the at least one reservoir is projected from the outer layer.

18. The method for insulating an exhaust gas treatment device according to claim 17, wherein the at least one reservoir is configured to be positioned in a circumferential orientation of the outer layer.

19. The method for insulating an exhaust gas treatment device according to claim 17, wherein the at least one reservoir is configured to be positioned in a longitudinal orientation of the outer layer.

20. The method for insulating an exhaust gas treatment device according to claim 17, wherein the at least one reservoir is configured to be vertically positioned at an uppermost point of the device when the device is mounted in a vehicle.

21. The method for insulating an exhaust gas treatment device according to claim 15, wherein the insulation material is selected from the group consisting of aerogel, perlite, roving, string, and an insulation blanket.

22. The method for insulating an exhaust gas treatment device according to claim 21, wherein the insulation material comprises microporous insulation.

23. The method for insulating an exhaust gas treatment device according to claim 15, wherein a volume of insulation material stored in the at least one reservoir is proportional to a rate in which the insulation material densifies when stored in the enclosed space, wherein the rate in which the insulation material densifies represents a ratio of the difference between a volume of the insulation material in the enclosed space after the insulation material densifies and a volume of the insulation material in the enclosed space before the insulation material densifies to the volume of the insulation material in the enclosed space before the insulation material densifies.

24. The method for insulating an exhaust gas treatment device according to claim 23, wherein the rate in which the insulation material densifies ranges from about three to about ten percent.

25. The method for insulating an exhaust gas treatment device according to claim 15, wherein a volume of insulation material stored in the at least one reservoir is determined by a location of the at least one reservoir.

26. The method for insulating an exhaust gas treatment device according to claim 15, wherein the method additionally comprises:
placing the insulation material into a flow neck having a second enclosed space that is connected to the outer layer and in fluid communication therewith, wherein the insulation material is disposed in the second enclosed space; and
placing an insulation layer that at least partially surrounds a portion of the flow neck where a void space is created due to a densifying of the insulation material in the second enclosed space.

27. The method for insulating an exhaust gas treatment device according to claim 15, wherein the method additionally comprises placing the insulation material in the reservoir through a fill-hole, wherein the insulation layer is used to cover up the fill-hole after the insulation material is disposed in the reservoir.
